(19) United States
(12) Patent Application Publication
(10) Pub. No.: US 2026/0014799 A1
(43) Pub. Date: Jan. 15, 2026

(54) CELL-LADEN BIOINK CIRCULATION-ASSISTED INKJET-BASED BIOPRINTING TO MITIGATE CELL SEDIMENTATION AND AGGREGATION

(71) Applicant: Texas Tech University System, Lubbock, TX (US)

(72) Inventors: Jiachen Liu, Lubbock, TX (US); Changxue Xu, Lubbock, TX (US); Heqi Xu, Lubbock, TX (US); Md Shahriar, Lubbock, TX (US)

(21) Appl. No.: 18/995,598

(22) PCT Filed: Aug. 2, 2023
(86) PCT No.: PCT/US2023/071536

§ 371 Date: Jan. 16, 2025

Related U.S. Application Data
(60) Provisional application No. 63/394,897, filed on Aug. 3, 2022.

(51) Int. Cl. B41J 2/175; B41J 2/18

(52) U.S. Cl. CPC B41J 2/17596; B41J 2/18

(57) ABSTRACT

A system for active circulation of bioink in inkjet bioprinting, comprises a bioink reservoir, an inlet connected to a pump, an outlet from the pump to the bioink reservoir, wherein the pump circulates bioink from the inlet to the outlet.

### CROSS REFERENCE TO RELATED PATENT APPLICATIONS

The present application claims the priority and benefit under 35 U.S.C. § 119(e) of U.S. Provisional Patent Application Ser. No. 63/394,897, filed Aug. 3, 2022, entitled “CELL-LADEN BIOINK CIRCULATION-ASSISTED INKJET-BASED BIOPRINTING TO MITIGATE CELL SEDIMENTATION AND AGGREGATION.” U.S. Provisional Patent Application Ser. No. 63/394,897 is herein incorporated by reference in its entirety.

### STATEMENT OF GOVERNMENT RIGHTS

The invention described in this patent application was made with Government support under grant from the National Science Foundation, Contract Number CMMI-1762282. The Government has certain rights in the invention.

### TECHNICAL FIELD

The embodiments are generally related to the field of bioengineering. Embodiments further relate to the field of bioink. Embodiments are further related to the field of additive manufacturing. Embodiments are also related to bioprinting living cells. Embodiments are further related to cell-laden bioink circulation-assisted inkjet-based bioprinting to mitigate cell sedimentation and aggregation.

### BACKGROUND

3D printing was first developed for prototyping purposes in engineering fields. More recently additive manufacturing approaches have been adapted for use in the biomedical sciences in the form of bioprinting. Bioprinting may one day be able to assist in the reconstruction or wholesale manufacture of various organs and tissues. Notable specific applications include the manufacture of tissue-engineered constructs for bone, osteochondral, skin, and cardiac reconstruction.

Bioprinters use a combination of specialized hardware and software. While there are multiple types of bioprinting systems, inkjet-based bioprinting has emerged as a frontrunner for many applications. This method allows for complex systems to be printed with multiple cell types, and offers advantages such as precise controllability of droplet size and deposition, easy scale-up, high printing speed and resolution, and high post-printing cell viability.

One of the most important physical components of an inkjet bioprinter system is the bioink. Bioink used for 3D bioprinting generally comprises of two main components: biological materials and living cells. Biological materials mimic natural extracellular matrix (ECM) to promote cell attachment, proliferation, and migration. 3D artificial tissue models have been successfully fabricated using inkjet-based bioprinting, such as vascular-like structures, skin, and cartilage.

The bioink used for 3D bioprinting incorporates living cells. During printing, the buoyant force of the cells provided by the bioink is less than the gravitational force because of the density difference, resulting in cell sedimentation to the bottom of the bioink reservoir. As a result, the cell concentration at the bottom of the bioink reservoir increases significantly. Once the distance between adjacent cells becomes small enough, the cells adhere with each other to form the cell aggregates through cell-cell interaction. Cell sedimentation-induced cell aggregation has been extensively reported as a significant challenge to affect the printing reliability and quality. The accumulated aggregation also results in high risk of nozzle clogging with odd jetting performance. Numerous performance losses result from cell sedimentation-induced cell aggregation and the associated adhesion to the inner surface of the tube and piezoelectric inkjet dispenser.

Various approaches to mitigate cell sedimentation and the resultant cell aggregation in 3D bioprinting have been explored. These approaches are categorized into two types: bioink property manipulation and active stirring. For the bioink property manipulation, some have tried adding PM400 at concentration of 10-15% (w/v) into the bioink containing MCF-7 breast cancer with a concentration of 5×10⁵ cells/ml to achieve the nearly neutral buoyance for the suspended cells during drop-on-demand (DOD) inkjet printing. Others have implemented a piezoelectric inkjet using bioink containing 0.7% (w/v) alginate and human umbilical vein endothelial cells with a concentration of 5×10⁶ cells/ml. 5% (w/v) bovine serum albumin was added into the bioink to achieve the nearly neutral buoyancy and the cell sedimentation and aggregation was suppressed.

For the active stirring approach, some have used agitators designed into DOD inkjet printing including a shaft-driven axial flow impeller and an internally mounted cylindrical neodymium magnet. The agitators substantially reduced the cell aggregation.

Although the aforementioned mitigation approaches may be effective, there are some critical downsides. For bioink property manipulation, careful formulation is required to reduce the difference between the mass density of cells and bioink. Moreover, it is extremely difficult to accommodate multiple cell types in the bioink to simultaneously achieve neutral buoyancy because different types of cells have different cell mass densities.

Similarly, the active stirring, is a mechanical mixing-based solution. The shear stress directly imposed on the cells may result in cell damage, especially for some types of cells that are sensitive to mechanical stresses.

As such, there is a need in the art for new methods and cell-laden bioink circulation-assisted inkjet-based bioprinting to mitigate cell sedimentation and aggregation as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for an improved system and method for bioink.

It is another aspect of the disclosed embodiments to provide for bioink additive manufacturing.

It is another aspect of the disclosed embodiments to provide cell-laden bioink circulation-assisted inkjet-based bioprinting to mitigate cell sedimentation and aggregation.

The aforementioned aspects and other objectives and advantages can now be achieved as described herein. In an embodiment, a system for inkjet bioprinting, comprises a bioink reservoir, an inlet connected to a pump, an outlet from the pump to the bioink reservoir, wherein the pump circulates bioink from the inlet to the outlet. In an embodiment, the outlet is connected to the bioink reservoir above a bioink level in the bioink reservoir. In an embodiment, the inlet is connected to the bioink reservoir below a bioink level in the bioink reservoir. In an embodiment, the system for inkjet bioprinting further comprises a flowrate controller configured to control the flowrate of the pump. In an embodiment, the pump comprises a peristaltic pump. In an embodiment, the system for inkjet bioprinting further comprises a pneumatic controller configured to control back pressure in the bioink reservoir. In an embodiment, the system for inkjet bioprinting further comprises an inkjet dispenser operably connected to the bioink reservoir. In an embodiment, the system for inkjet bioprinting further comprises a waveform generator configured to provide an excitation voltage to the inkjet dispenser. In an embodiment, the system for inkjet bioprinting further comprises bioink comprising ECM and living cells.

In another embodiment, a system comprises an inkjet dispenser, a bioink reservoir configured to deliver bioink to the inject dispenser, an inlet connected to a pump, an outlet from the pump to the bioink reservoir, wherein the pump circulates bioink from the inlet to the outlet. In an embodiment, the outlet is connected to the bioink reservoir above a bioink level in the bioink reservoir, and wherein the inlet is connected to the bioink reservoir below a bioink level in the bioink reservoir. In an embodiment, the system further comprises a flowrate controller configured to control the flowrate of the pump. In an embodiment, the pump comprises a peristaltic pump. In an embodiment, the system further comprises a pneumatic controller configured to control back pressure. In an embodiment, the bioink comprises ECM and living cells.

In an embodiment, a bioink circulation system, comprises a bioink reservoir, an inlet connected to a peristaltic pump, a flowrate controller configured to control the flowrate of the peristaltic pump, and an outlet from the peristaltic pump to the bioink reservoir. In an embodiment the outlet is connected to the bioink reservoir above a bioink level in the bioink reservoir. In an embodiment, the inlet is connected to the bioink reservoir below a bioink level in the bioink reservoir. In an embodiment, the bioink circulation system further comprises a pneumatic controller configured to control back pressure in the bioink reservoir. In an embodiment, the system is configured for circulate bioink comprising ECM and living cells.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a bioink printing system, in accordance with the disclosed embodiments;

FIG. 2 illustrates force and velocity diagrams, in accordance with the disclosed embodiments;

FIG. 3A illustrates aspects of a bioink reservoir, in accordance with the disclosed embodiments;

FIG. 3B illustrates a flow chart of iterations with time steps, in accordance with the disclosed embodiments;

FIG. 4A illustrates a chart of cell sedimentation and aggregation, in accordance with the disclosed embodiments;

FIG. 4B illustrates a chart of cell sedimentation and aggregation at the bottom of a bioink reservoir, in accordance with the disclosed embodiments;

FIG. 5A illustrates a chart of cell sedimentation, in accordance with the disclosed embodiments;

FIG. 5B illustrates a chart cell aggregation, in accordance with the disclosed embodiments;

FIG. 5C illustrates a chart of cell sedimentation mitigation effectiveness, in accordance with the disclosed embodiments;

FIG. 6A illustrates a chart of cell concentrations at the top and bottom of a bioink reservoir with and without circulation, in accordance with the disclosed embodiments;

FIG. 6B illustrates a chart of cell aggregation with and without circulation, in accordance with the disclosed embodiments;

FIG. 7 illustrates an image of a blocked nozzle, in accordance with the disclosed embodiments;

FIG. 8 provides an image of cell distribution in a nozzle, in accordance with the disclosed embodiments;

FIG. 9A provides fluorescence images of cell viability, in accordance with the disclosed embodiments;

FIG. 9B illustrates a chart of cell viability, in accordance with the disclosed embodiments;

FIG. 10 depicts a block diagram of a computer system which is implemented in accordance with the disclosed embodiments;

FIG. 11 depicts a graphical representation of a network of data-processing devices in which aspects of the present embodiments may be implemented; and

FIG. 12 depicts a computer software system for directing the operation of the data-processing system depicted in FIG. 10, in accordance with an embodiment.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

The embodiments presented herein are directed to a bioink circulation-assisted inkjet printing system, and associated methods, to mitigate cell sedimentation and the resultant cell aggregation without manipulating bioink properties.

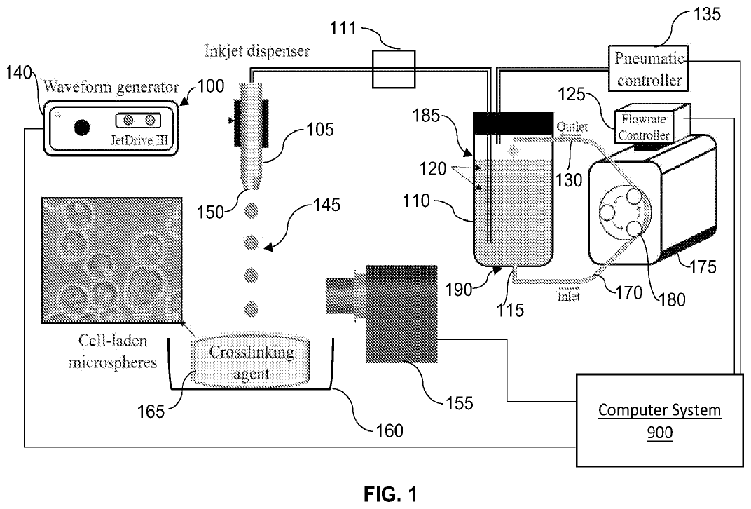

FIG. 1 illustrates aspects of a system 100, in accordance with the disclosed embodiments. The system 100 comprises an inject dispenser 105 in operational connection with a bioink reservoir 110. An inlet 115 allows bioink 120 in the bioink reservoir 110 to flow into a flowrate controller 125, which can further include an associated outlet 130 connecting back into the bioink reservoir 110. The bioink reservoir 110 can be controlled with a controller 135, which can be embodied as a pneumatic controller, or other such controller.

The bioink 120 in the bioink reservoir 110 can be pumped with a pump 111, to the inkjet dispenser 105, which can have an associated waveform generator 140. The inkjet dispenser 105 then deposits the cell-laden droplets 145 in a desired pattern for bioprinting.

The prepared bioink 120 can comprise an extracellular matrix (ECM) and living cells. The ECM can be a 3D network consisting of macromolecules and minerals (e.g., collagen, enzymes, etc.) which provide structural and biochemical support to surrounding cells. Sodium alginate (NaAlg) is an exemplary ECM for bioprinting and tissue engineering to facilitate cellular attachment, proliferation, and differentiation due to its biocompatibility, biodegradation, hydrophilicity, and low cost. NIH 3T3 mouse fibroblasts (ATCC, Rockville, MD), represents an exemplary type of cell of connective tissues in mammal, and can be selected as the model cell in accordance with the disclosed embodiments.

An NaAlg solution can be prepared by dissolving NaAlg powder (Sigma-Aldrich, St. Louis, MO) into the Dulbecco's Modified Eagles Medium (DMEM; Sigma-Aldrich, St. Louis, MO) with a concentration of 0.5% (w/v). The NIH 3T3 mouse fibroblasts are cultured in Dulbecco's Modified Eagles Medium (DMEM; Sigma-Aldrich, St. Louis, MO) supplemented with 10% Bovine Calf Serum (BCS; Hyclone, Manassas, VA) and 1% antibiotic/antimycotic solution (Corning, Manassas, VA) in a humidified 5% CO₂ incubator at 37° C. The culture medium can be changed periodically. The cells cultured in the flasks are detached by adding 0.25% Trypsin/EDTA (Sigma-Aldrich) for 5-minute incubation. The resulting cell suspension can be centrifuged for 5 minutes at a speed of 1000 rpm and room temperature to obtain the cell pellet, which can be resuspended in the 0.5% (w/v) NaAlg solution. The final bioink has a cell concentration of 1×10⁶ cells/ml and 5×10⁶ cells/mi. It should be appreciated that this represents one exemplary bioink but other bioink solutions can also be used without departing from the scope disclosed herein.

FIG. 1 further shows the setup of a bioink circulation-assisted inkjet printing system 100 in accordance with the disclosed embodiments. The system 100 comprises a customized bioink reservoir 105 with active circulation, a pneumatic controller 135 to optimize the back pressure, an inkjet dispenser 105 with an orifice 150 diameter of, for example, 120 μm, a waveform generator 140 providing an excitation voltage signal to the inkjet dispenser 105, an imaging system 155 to capture the droplet formation process, and a substrate container 160 with the crosslinking agent 165 of, for example, 2% (w/v) calcium chloride solution.

In an exemplary embodiment, the customized bioink reservoir with active circulation includes a bioink reservoir 110 with inner diameter of 8 mm and volume capacity of 1.5 ml. A biocompatible silicone tube 170 with inner diameter of 0.5 mm and length of 35 cm connects at the top and bottom of the bioink reservoir 110, and pump 175, which can comprise a peristaltic pump, which enables adjustment of the flow rates in the range of 0.002-2 ml/min. The peristaltic pump 175 is equipped with a 10-roller rotor 180 which extracts the bioink 120 from the bottom 185 of bioink reservoir 110 and replenishes it to the top 190 to achieve active circulation of the bioink 120 within the reservoir 110. It is noted that the outlet end 130 of the tube 170 is located right above the bioink 120 liquid level rather than being submerged into the bioink bulk to secure a consistent and holistic circulation within the bioink reservoir 110.

In certain embodiments, the system 100 can also be run in reverse by circulating bioink 120 from the top 185 to the bottom 190 of the bioink reservoir 110. However, for this operation, continuous and precise control of the tube outlet 130 level is required to match the decreasing bioink liquid level due to the bioink consumption during printing.

The disclosed systems and methods illustrate the effects of active bioink circulation on the cell sedimentation and aggregation in inkjet-based bioprinting. The major exemplary conditions are summarized in Table 1.

TABLE 1

| Experimental condition | Unit | Value |
|---|---|---|
| Circulation flow rate | ml/min | 0.01, 0.05, 0.1, 0.5 |
| NaAlg concentration | w/v | 0.5% |
| Cell concentration | cells/ml | 1 × 10⁶, 5 × 10⁶ |
| Printing time | minutes | 20, 40, 60 |
| Bioink volume | ml | 1 |

In certain exemplary embodiments, the circulation flow rate can be selected to be in the range of 0.01-0.5 ml/min. The typical cell concentration in this exemplary embodiment is 1×10⁶ cells/ml, which is commonly used in 3D bioprinting. The high cell concentration of 5×10⁶ cells/ml, results in severe cell sedimentation and aggregation without circulation, which illustrates the high effectiveness of the disclosed active circulation approach using the system 100.

Likewise, in certain embodiments, the printing time can be in the range of 0-60 minutes with an interval of 20 minutes. The bioink containing 0.5% (w/v) NaAlg may be selected due to the prominent cell sedimentation phenomenon. The initial bioink volume can be fixed to 1 ml. The process parameters of the applied exemplary excitation waveform can be fixed as follows: excitation voltage 60 V, rise time 3 μs, dwell time 25 μs, fall time 5 μs, echo time 30 μs, and final rise time 3 μs.

Cell sedimentation can be quantified by measuring cell concentrations at the top and bottom of the bioink reservoir 110. For example, for a 10 μl bioink sample, collected and added into a hemocytometer for measurement of the cell concentration, the cell aggregation can be quantified by classifying it into three types depending on the aggregation level: individual cells without aggregation, small cell aggregates containing 2-4 cells, and large cell aggregates containing at least 5 cells. The percentage of individual cells can be characterized by equation (1) as:

$$ic \% = \frac{{\sum }_{α = 1} a b}{Total number of cells} \times 100 \% \qquad ( 1 )$$

where a is 1 for individual cell, and b is the associated appearance frequency of individual cells. The percentage of the cells forming small aggregates was characterized by equation (2) as:

$$sa \% = \frac{{\sum }_{a = 2}^{4} a b}{Total number of cells} \times 100 \% \qquad ( 2 )$$

where a is in the range of 2-4 representing the cell number contained in the small aggregates, and b is the associated appearance frequency of small aggregates. The percentage of the cells forming large aggregates is characterized by equation (3):

$$la \% = \frac{{\sum }_{a = 5}^{c} a b}{Total number of cells} \times 100 \% \qquad ( 3 )$$

where c is the maximum cell number in the cell aggregates, a is in the range of 5—c representing the number of the cells in the large aggregates, and b is the associated appearance frequency of large aggregates.

In certain embodiments, a fluorescence assays comprising calcein AM and ethidium homodimer III (Biotium, Fremont, CA) can be utilized to assess the cell viability. The protocol is as follows: (1) mixing calcein AM and ethidium homodimer III with Dulbecco's Modified Eagle Medium (DMEM) to make the staining solution; (2) adding the samples into the staining solution and incubating for 20 minutes in a humidified 5% CO₂ incubator at 37° C.; and (3) imaging the stained cells using a fluorescence microscope. Calcein AM is membrane-permeant and emits strong green fluorescence for the living cells, and the ethidium homodimer III is membrane-impermeant and binds to DNA emitting red fluorescence. Cell viability is defined as a ratio of the number of living cells over the total number of cells.

Illustrated data is presented herein in support of the disclosed systems and methods. Data is shown in mean values±standard deviation. To test the significance of difference among the different datasets, one-way analysis of variance (ANOVA) and Tukey multiple comparisons test were performed using the software. P<0.05 (*) represents the statistical significance.

Cell sedimentation phenomenon is mainly governed by the cell gravitational force, buoyant force, and drag force. Gravitational force and buoyant force are defined as follows, by equations (4) and (5) respectively:

$$G = {ρ}_{cell} {V}_{cell} g \qquad ( 4 )$$

$${F}_{B} = {ρ}_{f} {V}_{cell} g \qquad ( 5 )$$

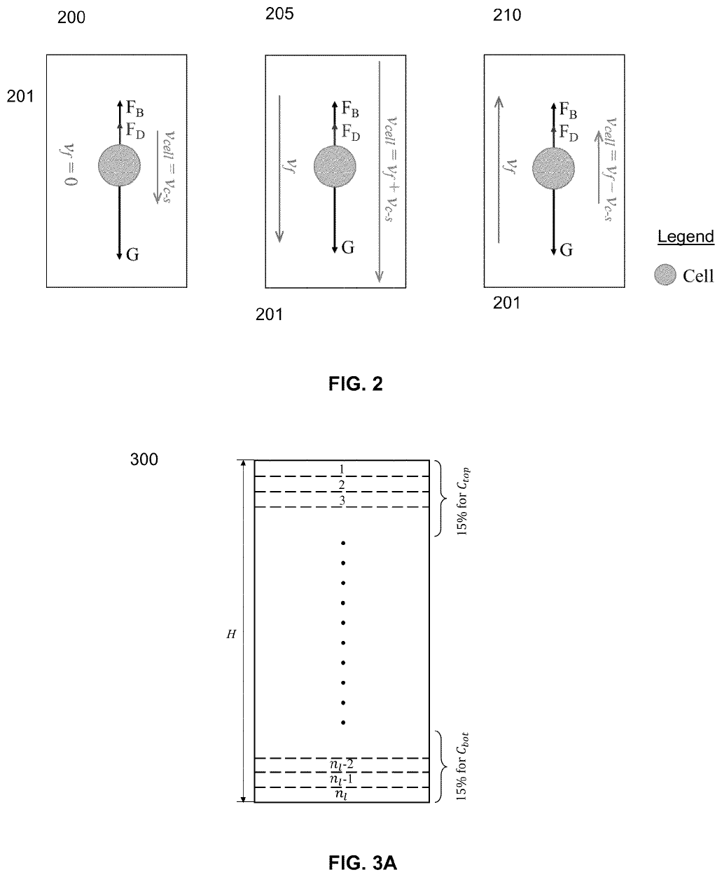

In these equations, ρ_{cell} is the cell density, ρᵣ is the fluid density, g is gravitational acceleration, and V_{cell} is the volume of the cell. When the bioink is stationary, the suspended cells sediment to the bottom of the bioink reservoir because the cell gravitational force is greater than the cell buoyant force at initial. Drag force is relevant where there is relative motion between the cells and the surrounding fluid. The drag force is the resistance force opposite to the motion of the cells relative to the surrounding fluid. It is calculated by the following formula:

$${F}_{D} = \frac{1}{2} {ρ}_{f} {v}_{c}^{2} {C}_{d} A \qquad ( 6 )$$

where v_{c} is the velocity of cells in motion relative to the surrounding fluid, C_{d} is the drag coefficient, and A is the cross-sectional area of the cells. The drag coefficient C_{d} is related to the Reynolds number Re, defined as

$$Re = \frac{{ρ}_{f} {v}_{c} D}{μ} ,$$

where D is the cell diameter, and μ is the dynamic viscosity of the fluid. ρ_{f}, A, D, and μ are generally unaltered during the printing process and v_{c} is deemed to influence the magnitude of the drag force. At force equilibrium, the cell gravitational force is balanced by the cell buoyant force and drag force on the cell 201, as shown in force diagram 200 of FIG. 2. The cell sedimentation velocity has no significant change during the sedimentation process. For the bioink containing 0.5% (w/v) NaAlg, the cell sedimentation velocity at static fluid (v_{c-s}) is around 1.45 μm/s. When the circulation is implemented, the peristaltic pump continuously transfers the bioink from the bottom to the top of the bioink reservoir with a fluid velocity v_{f}. In the bioink reservoir, the fluid velocity is downward. After force equilibrium, the cell gravitational force is balanced by the cell buoyant force and drag force. The cell velocity is v_{cell}=v_{f}+v_{c-s} shown in force diagram 205 FIG. 2. In the circulation tube, the fluid velocity is upward. After force equilibrium, the cell gravitational force is balanced by the cell buoyant force and drag force. The cell velocity is v_{cell}=v_{f}−v_{c-s}, as shown in force diagram 210 shown in FIG. 2.

### Experimental Results

A study was completed where active circulation as disclosed herein, with the bioink reservoir 110 was used to mitigate the cell sedimentation and aggregation. An associated cell sedimentation model is presented showing the local cell concentrations at the top and bottom of the bioink reservoir. The cell sedimentation and aggregation are also compared with and without the active bioink circulation, demonstrating the effectiveness of the embodiments disclosed herein. The effects of the circulation flow rate on the cell sedimentation and aggregation are also illustrated. The effects of the circulation flow rate on the cell sedimentation and aggregation for high cell concentration, demonstrate the wide applicability/adaptability of the disclosed embodiments.

### Circulation

It is noted that the disclosed circulation model is based on sedimentation of individual cells without aggregation. During the circulation, the applied flow rate is Q_{f}. The fluid velocities in the bioink reservoir and the circulation tube can be calculated, respectively, as:

$${v}_{f - r} = \frac{{Q}_{f}}{{A}_{r}} \qquad ( 7 )$$

$${v}_{f - t} = \frac{{Q}_{f}}{{A}_{t}} \qquad ( 8 )$$

where v_{f-r} is the fluid velocity in the bioink reservoir, Aᵣ is the cross-sectional area of the bioink reservoir, v_{f-t} is the fluid velocity in the circulation tube, and Aₜ is the cross-sectional area of the tube. The cell velocities in the bioink reservoir and the circulation tube are calculated, respectively, as:

$${v}_{c - r} = {v}_{f - r} + {v}_{c - s} \qquad ( 9 )$$

$${v}_{c - t} = {v}_{f - t} - {v}_{c - s} \qquad ( 10 )$$

where v_{c-f} is the cell velocity in the bioink reservoir, and v_{c-f} is the cell velocity in the circulation tube. The flow rates selected can be 0.01-1 ml/min. The calculated fluid velocity in the circulation tube is v_{f-t}=1-100 mm/s, which is significantly higher than the cell sedimentation velocity in the static flow v_{c-s}=1.45 μm/s. Hence, the fluid velocity and cell velocity in the circulation tube have no significant difference. The cell sedimentation in the circulation tube is also neglected in the model. However, the magnitude of the fluid velocity in the bioink reservoir is v_{f-r}=1-100 μm/s, which is comparable to v_{c-s}. Therefore, the modeling in this example focuses on the cell sedimentation within the bioink reservoir.

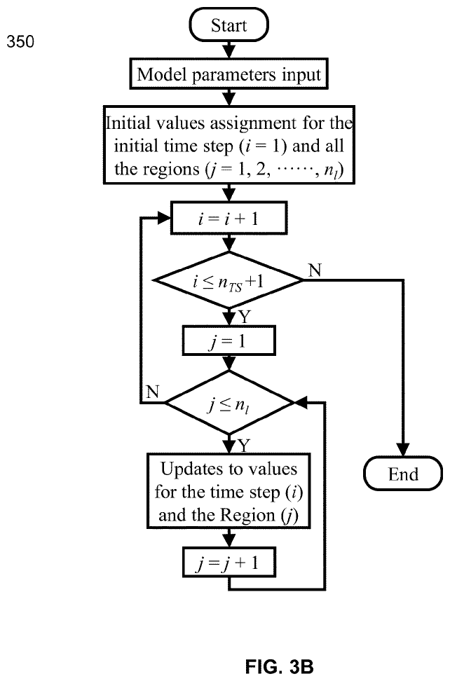

FIG. 3A illustrates a chart 300, where regions are divided and numbered within the bioink reservoir. FIG. 3B illustrates a flow chart 350 showing the iteration with the time step for each divided region where n_{TS} is the number of the iteration within an infinitesimal space, the ratio of the number of cells at the end and the beginning of the time period can be calculated using the following equation:

$$\frac{n {c}_{end}}{n {c}_{start}} = \frac{C \cdot {A}_{r} \cdot {ν}_{f - r} \cdot t - C \cdot {A}_{r} \cdot {v}_{c - s} \cdot t}{C \cdot {A}_{r} \cdot {v}_{f - r} \cdot t} = \frac{{ν}_{f - r} - {ν}_{c - s}}{{v}_{f - r}} \qquad ( 11 )$$

Where nc_{end} is the number of cells at the end of the time step, nc_{Start} is the number of cells at the beginning of the time step, C is the cell concentration within the space, and t is the time step. The height of the bioink reservoir is H, and the bioink reservoir is divided into nl regions with a height of H/nₗ. Each region is numbered as shown in FIG. 3A. The system is based on iteration with the time step for each divided region. The number of cells in region 1 at the end of the time step can be calculated as:

$$n c ( i + 1 , 1 ) = n c ( i , 1 ) \cdot \frac{{v}_{f - r} - {v}_{c - s}}{{v}_{f - r}} \qquad ( 12 )$$

The number of cells in Regions 2-nₗ-1 at the end of the time step can be calculated as:

$$n c ( i + 1 , j ) = n c ( i , j ) \cdot \frac{{v}_{f - r} - {ν}_{c - s}}{{v}_{f - r}} + n c ( i , j - 1 ) - n c ( i + 1 , j - 1 ) \qquad ( 13 )$$

where i is the ith time step, and j is the number of the region. The number of cells in Region nₗ at the end of the time step can be calculated as:

$$n c ( i + 1 , {n}_{l} ) = n c ( i , {n}_{l} ) \cdot \frac{{v}_{f - r}}{{v}_{f - r}} + n c ( i , {n}_{l} - 1 ) - n c ( i + 1 , {n}_{l} - 1 ) \qquad ( 14 )$$

During iteration, the total number of cells in the bioink reservoir remains constant. The measurement area of cell concentration is the 15% of the bioink reservoir at the top and the bottom. The cell concentrations at the top and the bottom of the bioink reservoir are calculated using the following equations, respectively:

$${C}_{top} = \frac{{\sum }_{j = 1}^{0.15 {n}_{l}} n c ( {n}_{TS} , j )}{0.15 \cdot {A}_{r} \cdot h} \qquad ( 15 )$$

$${C}_{bot} = \frac{{\sum }_{j = 0.85 {n}_{l}}^{{n}_{l}} n c ( {n}_{TS} , j )}{0.15 \cdot {A}_{r} \cdot h} \qquad ( 16 )$$

where n_{TS} is the time step number. The flow chart 350 in FIG. 3B shows the iteration with the time step for each divided region. The parameters used in the model are listed in Table 2.

TABLE 2

| Model Parameters | Unit | Value |
|---|---|---|
| Radius of bioink reservoir | mm | 4 |
| System flow rate (Q_{f}) | ml/min | 0.01-0.5 |
| Relative cell sedimentation velocity (v_{c-s}) | μm/s | 1.45 |
| Fluid velocity within bioink reservoir (vₜ₋ᵣ) | mm/s | 3.32-166 × 10⁻³ |
| Height of bioink (H) | mm | 19.9 |
| Number of regions (nₗ) | | 10000 |
| Total printing time | s | 3600 |
| Time step (t) | s | 1.37 |

Cell sedimentation and aggregation are compared using the inkjet printing system with active circulation as disclosed herein, and without active circulation. In this comparison, the top and the bottom of the bioink reservoir are selected to quantify the cell sedimentation and aggregation, representing the uniformity of the bioink the reservoir. The cell sedimentation is quantified using the local cell concentrations at the top and bottom of the bioink reservoir. The cell aggregation is quantified using the percentage of the three types of the cell aggregates at the bottom of the bioink reservoir including individual cells without aggregation, small aggregates with 2-4 cells, and large aggregates with at least 5 cells. Two circulation conditions are applied as with active circulation of 0.5 ml/min and without active circulation. The bioink contains 0.5% (w/v) NaAlg and a cell concentration of 1×10⁶ cells/ml.

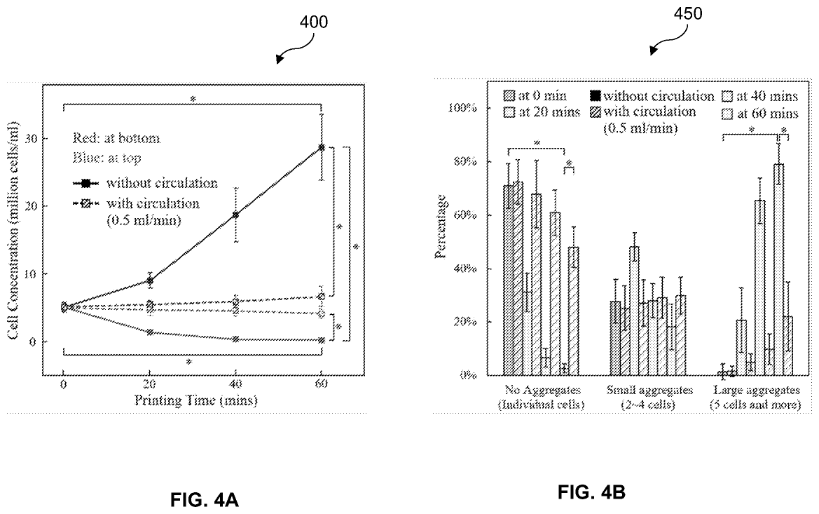

In chart 400 of FIG. 4A, the comparison of the cell concentrations at the top and bottom of the bioink reservoir with active circulation as disclosed, and without the active circulation are illustrated. Without the active circulation, as the printing time increases from 0 to 20 to 40 to 60 minutes, the cell concentration on the top of the bioink reservoir decreases significantly from 1.00 to 0.29 to 0.1 to 0.07×10⁶ cells/mi mainly due to cell sedimentation. After the 60 minutes, the cell concentration on the top is significantly reduced by 93%. Very few cells remain on the top of the bioink reservoir. On the contrary, as the printing time increases from 0 to 20 to 40 to 60 minutes, the cell concentration at the bottom of the bioink reservoir increases significantly from 1.01 to 1.56 to 2.42 to 3.68×10⁶ cells/mi mainly due to cell sedimentation. After the 60 minutes, the cell concentration at the bottom significantly increased by nearly 268%. Numerous cells sediment to the bottom of the bioink reservoir, significantly increasing the local cell concentration. The highly non-uniform bioink due to the cell sedimentation is demonstrated by comparing the local cell concentrations at the top 0.07×10⁶ cells/ml and at the bottom 3.68×10⁶ cells/ml.

With the active circulation as disclosed herein, of 0.5 ml/min, as the printing time increases from 0 to 20 to 40 to 60 minutes, the cell concentration at the top of the bioink reservoir slightly decreases from 1.00 to 0.99 to 0.97 to 0.96×10⁶ cells/ml, and the cell concentration at the bottom of the bioink reservoir slightly increases from 1.01 to 1.04 to 1.06 to 1.06×10⁶ cells/mi. After the printing time of 60 minutes, the cell concentrations at the top and the bottom are 0.96×10⁶ cells/ml and 1.06×10⁶ cells/mi, respectively. The bioink within the reservoir is relatively uniform in the cell concentration, which demonstrates the high effectiveness of the active circulation to mitigate the cell sedimentation as disclosed herein.

Chart 450 in FIG. 4B shows the comparison of the cell aggregation at the bottom of the bioink reservoir with active circulation as disclosed herein, and without the active circulation. Without the active circulation, as the printing time increases from 0 to 20 to 40 to 60 minutes, the percentage of the individual cells without aggregation decreases significantly from 96.68 to 80.00 to 60.99 to 32.83%, while that of the small aggregates increases significantly from 3.32 to 19.21 to 37.63 to 49.24%, and that of the large aggregates also increases significantly from 0.00 to 0.79 to 1.38 to 17.93%. After 60 minutes, the percentage of the individual cells is only 32.83%, and that of the small aggregates and that of the large aggregates are 49.24% and 17.93%, respectively. The distribution of three types of cell aggregates demonstrates the significance of the cell aggregation challenge in 3D bioprinting. However, with the active circulation as disclosed herein, of 0.5 ml/min, as the printing time increases from 0 to 20 to 40 to 60 minutes, the percentage of the individual cells without aggregation decreases from 96.36 to 95.21 to 91.20 to 86.79%, while that of the small aggregates increases from 3.64 to 4.50 to 8.22 to 10.71%, and that of the large aggregates slightly increases from 0.00 to 0.29 to 0.58 to 2.50%. After 60 minutes, the percentage of the individual cells is 86.79%, and that of the small and that of the large aggregates are 10.71% and 2.50%, respectively. In comparison, the percentages of the cell aggregates are 67.17% without the active circulation and 13.21% with the active circulation. The formation of cell aggregates within the bioink reservoir is significantly suppressed, which demonstrates the high effectiveness of the active bioink circulation as disclosed herein, to mitigate cell aggregation.

### Effects of Circulation Flow Rate on Cell Sedimentation and Aggregation

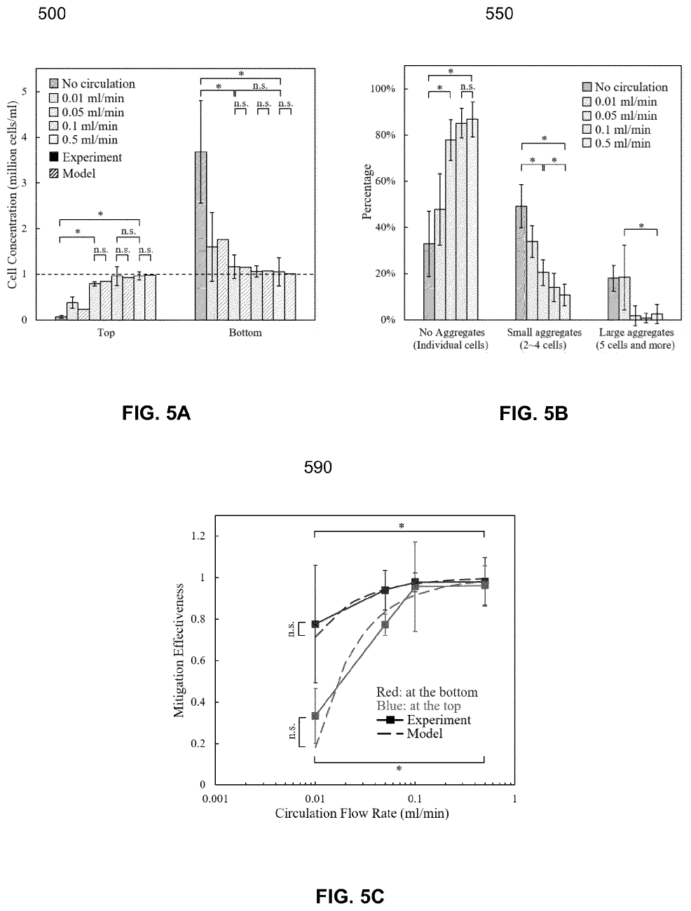

In accordance with the disclosed embodiments, chart 500 in FIG. 5A shows the effect of active bioink circulation flow rate on cell sedimentation at the top and the bottom of the bioink reservoir at 60 minutes. Initially, the cell concentration is 1×10⁶ cells/ml for both the top and bottom. As the flow rate increases from 0 to 0.01 to 0.05 to 0.1 to 0.5 ml/min, the measured cell concentration at the top increases significantly from 0.07 to 0.38 to 0.79 to 0.96 to 0.96×10⁶ cells/ml, while that at the bottom decreases significantly from 3.68 to 1.60 to 1.16 to 1.06 to 1.06×10⁶ cells/ml. Moreover, the mitigation of the cell sedimentation at the flow rate of 0-0.05 ml/min is more significant than that at the flow rate of 0.05-0.5 ml/min. As the flow rate increases from 0 to 0.05 ml/min, the respective cell concentration at the top and that at the bottom are significantly increased by more than ten times and decreased by 68%, while there is only 23% and 9% improvement, respectively, as the flow rate increases from 0.05 to 0.5 ml/min. This indicates that the effectiveness of the circulation on the cell sedimentation is dependent on the flow rate. Large flow rate results in slow increments in effectiveness. In addition, the model utilized to illustrate the local cell concentrations at the top and bottom of the bioink reservoir under different circulation flow rates. As the flow rate increases from 0.01 to 0.05 to 0.1 to 0.5 ml/min, the predicted cell concentration at the top increases from 0.24 to 0.85 to 0.92 to 0.99×10⁶ cells/mi, while the predicted cell concentration at the bottom decreases from 1.76 to 1.15 to 1.08 to 1.02×10⁶ cells/ml. The comparison of the predictions by the model and the experimental results shows good agreement. It is noted that the predicted top cell concentration at flow rate of 0.01 ml/min is less than the experimental results, and the predicted bottom cell concentration bottom at flow rate of 0.01 ml/min is greater than the experimental results. The main reasons are the variation of the cell sedimentation velocity and the formation of cell aggregates.

In accordance with the disclosed embodiments chart 550 in FIG. 5B shows the effect of active bioink circulation flow rate on cell aggregation at the bottom of the bioink reservoir at 60 minutes. As the flow rate increases from 0 to 0.01 to 0.05 to 0.1 to 0.5 ml/min, the measured percentage of the individual cells without aggregation increases significantly from 32.83% to 47.81% to 77.80% to 85.14% to 86.79%, while the percentage of cells forming the small aggregates decreases significantly from 49.24% to 33.87% to 20.48% to 14.03% to 10.71%. At the flow rate of 0-0.01 ml/min the percentage of cells forming the large aggregates is around 18%, and at the flow rate of 0.01-0.5 ml/min the percentage of cells forming the large aggregates is significantly reduced to less than 2.6%. Regarding improvement, comparing the flow rate increase from 0 to 0.05 ml/min with that from 0.05 to 0.5 ml/min, the former improvement percentage of the individual cells without aggregation is 44.97% while the latter is only 8.99%. The respective improvement percentages for the cells forming small aggregates are 28.76% and 9.77% and that for the cells forming large aggregates are 16.21% and −0.78%. Generally, large flow rate results in slow increments in effectiveness. Although the effectiveness of the circulation on the cell aggregation is dependent on the flow rate, it is more complex than that on the cell sedimentation because of the implicit transformation between the small aggregates and the large aggregates.

Chart 590 in FIG. 5C shows the mitigation effectiveness percentage on cell sedimentation. The local cell concentrations at the top and bottom of the bioink reservoir with different circulation flow rates are normalized based on those without circulation. It is seen that as the flow rate increases from 0.01 to 0.05 to 0.1 to 0.5 ml/min, the mitigation effectiveness on cell sedimentation at the top increases significantly from 33.38% to 77.38% to 95.68% to 96.26%, and that at the bottom also increases significantly from 77.71% to 94.01% to 97.82% to 98.09%. This observation indicates that the mitigation effectiveness on the cell sedimentation at the top is more pronounced that that at the bottom. This is mainly due to the circulation of the bioink from the bottom to the top, significantly replenishing the total cell number at the top of the bioink reservoir. In addition, the model illustrates the mitigation effectiveness on local cell concentrations at the top and bottom of the bioink reservoir under different circulation flow rates. As the flow rate increases from 0.01 to 0.05 to 0.1 to 0.5 ml/min, the predicted mitigation effectiveness on cell sedimentation at the top increases significantly from 18.09% to 83.48% to 91.65% to 98.19%, and the predicted mitigation effectiveness on cell sedimentation at the bottom increases significantly from 71.51% to 94.35% to 97.21% to 99.49%. The model prediction generally agrees well with the experimental results, except for a slight underestimation at the low flow rates. The main reasons are the variation of the cell sedimentation velocity and the formation of cell aggregates. Moreover, with the increase of the circulation flow rate, the mitigation effectiveness generally increases and approaches to 100%. At the flow rate of 0.1 ml/min, the mitigation effectiveness is around 95%, and after 0.1 ml/min the improvement in the mitigation effectiveness becomes very slow. The results regarding the mitigation effectiveness on the cell sedimentation demonstrates the high effectiveness of the disclosed active circulation in mitigating cell sedimentation.

Circulation Effects on Cell Sedimentation and Aggregation Using Bioink with High Cell Concentration

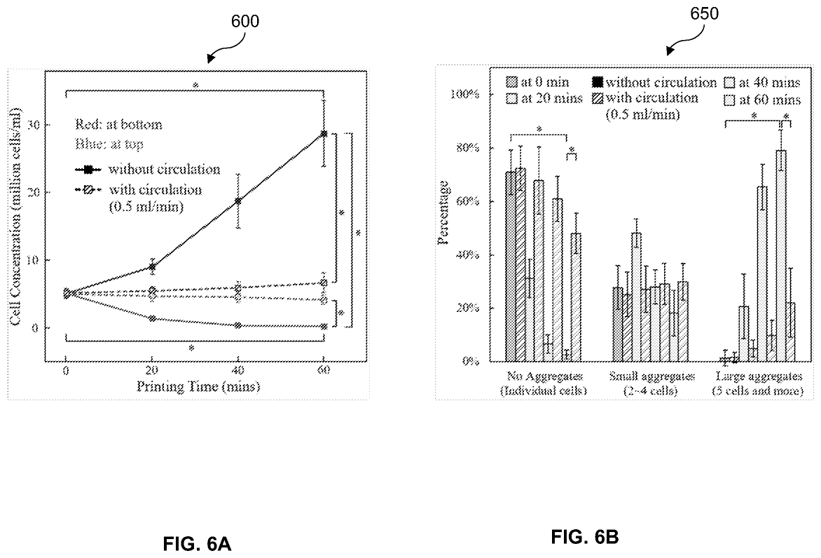

The systems and methods disclosed herein are further advantageous for use with bioink having high cell concentration. To investigate the mitigation effectiveness of active bioink circulation on cell sedimentation and aggregation with high cell concentration, 5×10⁶ cells/ml were selected at the exemplary circulation flow rate of 0.5 ml/min. Chart 600 in FIG. 6A shows the comparison of the cell concentrations at the top and the bottom of the bioink reservoir with active circulation as disclosed herein, and without the active circulation. Without the active circulation, as the printing time increases from 0 to 20 to 40 to 60 minutes, the cell concentration at the top decreases significantly from 5.09 to 1.34 to 0.34 to 0.23×10⁶ cells/ml, while the cell concentration at the bottom increases significantly from 5.07 to 9.03 to 18.75 to 28.75×10⁶ cells/ml. After 60 minutes, the cell concentration on the top is reduced by 95%, while the cell concentration at the bottom is increased by nearly 467%. A large number of cells sediment to the bottom of the bioink reservoir, significantly increasing the local cell concentration. The bioink in the reservoir is highly non-uniform due to cell sedimentation by comparing the local cell concentrations at the top—0.2×10⁶ cells/ml and at the bottom—28.75×10⁶ cells/ml.

With the active circulation, as disclosed herein, of, for example, 0.5 ml/min, as the printing time increases from 0 to 20 to 40 to 60 minutes, the cell concentration at the top decreases from 4.98 to 4.68 to 4.54 to 4.13×10⁶ cells/ml, and the cell concentration at the bottom increases from 5.11 to 5.48 to 5.93 to 6.66×10⁶ cells/ml. After 60 minutes, the cell concentrations at the top and the bottom are 4.13×10\hat{ }6 cells/ml and 6.66×10⁶ cells/ml, respectively. The uniformity of the bioink in the reservoir is significantly improved at the 60 minutes mainly due to the active circulation, which demonstrates the effectiveness of the disclosed active circulation to mitigate the cell sedimentation with high cell concentration.

Chart 650 in FIG. 6B shows the comparison of the cell aggregation at the bottom of the bioink reservoir with active circulation as disclosed herein, and without the active circulation. Without the active circulation, as the printing time increases from 0 to 20 to 40 to 60 minutes, the percentage of the individual cells without aggregation decreases significantly from 70.88% to 31.17% to 6.67% to 2.62%, while the percentage of cells forming the small aggregates increases from 27.77% to 48.10% and then decreases to 28.00% to 18.26%, and the percentage of cells forming large aggregates increases significantly from 1.35% to 20.74% to 65.33% to 79.13%. After 60 minutes, the percentage of the individual cells is only 2.61%, while the percentages of cells forming the small and large aggregates are 18.26% and 79.13%, respectively. In comparison, with the active circulation of 0.5 ml/min, as the printing time increases from 0 to 20 to 40 to 60 minutes, the percentage of the individual cells without aggregation decreases from 72.39% to 67.89% to 60.98% to 48.06%, while the percentage of cells forming small aggregates increases from 25.25% to 27.18% to 29.17% to 29.85%, and the percentage of cells forming the large aggregates increases from 1.52% to 4.93% to 9.84% to 22.09%. After 60 minutes, the percentage of the individual cells is 48.06%, and the percentages of cells forming the small and large aggregates are 29.85% and 22.09%, respectively. The percentage of the cells forming aggregates are 97.38% without the active circulation compared to 51.94% with the active circulation. With the active circulation, the formation of cell aggregates within the bioink reservoir is significantly reduced by almost 47%, which demonstrates the effectiveness of the disclosed active circulation to mitigate the cell aggregation even with a high cell concentration. It is noted that more cell aggregates are observed in this case with cell concentration of 5×10⁶ cells/ml compared to the case with cell concentration of 1×10⁶ cells/ml. This is mainly because the distance between adjacent cells is smaller, and it is much easier to form cell aggregates through cell-cell interaction at a high cell concentration.

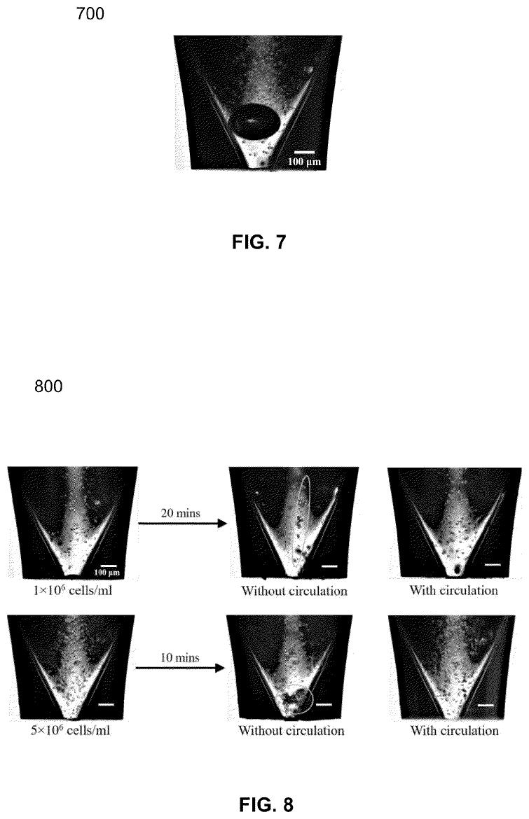

General speaking, high flow rates improve the mitigation performance regarding the cell aggregation during the printing process. However, excessively high flow rates may result in large velocity fields at the top of the bioink reservoir, where the circulated bioink impacts with the bulk bioink. During the impaction, small bubbles may be generated. When the bubbles reach the nozzle, they are enlarged under the propagation of the pressure waves inside the nozzle. The size of the bubbles could become large enough to block the nozzle as shown in image 700 in FIG. 7. The bubble starts to form at the flow rate >0.5 ml/min. At the flow rate 0.5-1 ml/min, small bubbles are formed sometimes, which slightly affects the nozzle behaviors. At the flow rate >1 ml/min, the bubble formation is a significant issue that affects the nozzle behaviors.

In certain embodiments, the optimal flow rate for the bioink with low cell concentration is therefore 0.1-0.5 ml/min, although other flow rates are possible. It should be appreciated that the flow rate is also affected by the remaining volume of the bioink within the reservoir. With the printing time, the volume of the bioink within the reservoir decreases since some of the bioink is ejected out to form cell-laden microspheres. The height between the outlet of the circulation tube and the bioink surface is larger. The recommended flow rate may decrease slightly with the printing time considering the dynamic decrease of the bioink volume with the printing time.

After the bioink is transferred from the reservoir to the nozzle, the cell aggregation with and without the active circulation within the nozzle during the printing should be considered. FIG. 8 illustrates images 800 showing the cell aggregation with active circulation as disclosed herein, and without the active circulation within the nozzle during the printing. Two bioinks are used, one with a low cell concentration of 1×10⁶ cells/ml and one a high cell concentration of 5×10⁶ cells/ml. At the printing time of 0 minutes the cells are uniformly dispersed inside the nozzle. At the printing time of 20 minutes for low cell concentration and 10 minutes for high cell concentration, the cell aggregation becomes prominent without the active circulation. For the low cell concentration, two large cell aggregates are formed in FIG. 8 containing more than 10 cells. The cell aggregates appear in the vicinity of the nozzle centerline due to the weak shear-thinning effect of the bioink. Due to the formation of the cell aggregates, the bioink inside the nozzle becomes highly non-uniform. The droplet formation process is unstable, which makes it extremely difficult to precisely control the printing quality of the fabricated 3D structures. Due to the low cell concentration, the cell aggregate size is relatively small, and the nozzle blockage is not observed. For the high cell concentration, the cell aggregation is severe, and more large cell aggregates are observed. Sometimes, the largest cell aggregate contains more than 100 cells shown in FIG. 8. The size of the cell aggregate is even larger than the nozzle orifice size of 120 μm, and the nozzle orifice is blocked. However, with the active circulation of 0.5 ml/min flow rate, only few cell aggregates are observed for both cases shown in FIG. 8. Similar to the images at the printing time of 0 minutes, the cells are still uniformly dispersed inside the nozzle at the printing time of 20 minutes for the low cell concentration and 10 minutes for the high cell concentrations.

### Cell Viability

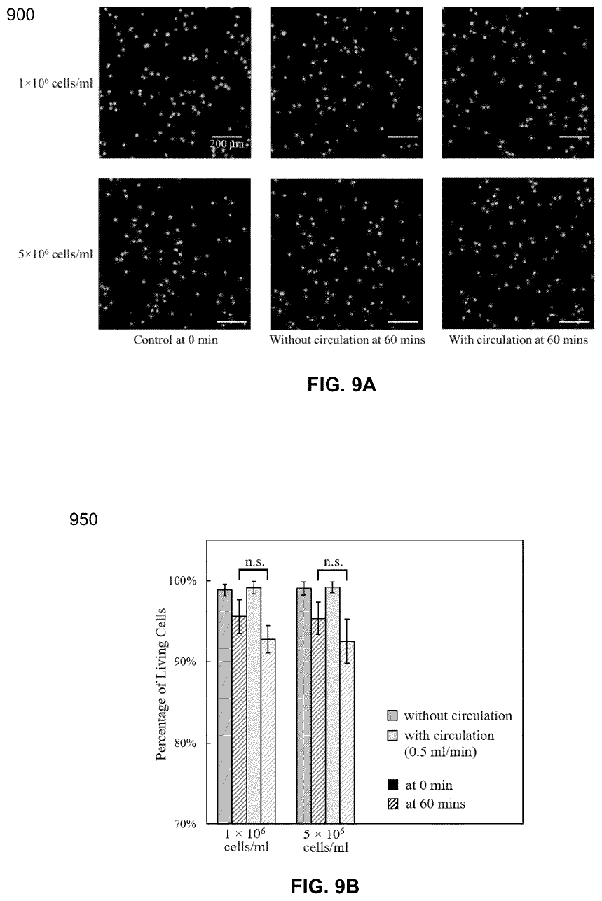

Cell viability of the cells in the bioink in association with the disclosed embodiments, was assessed using a fluorescence assay. Calcein AM is membrane-permeant and emits strong green fluorescence for the living cells, and the ethidium homodimer III is membrane-impermeant and binds to DNA emitting red fluorescence. Images 900 and chart 950 illustrated in FIGS. 9A and 9B respectively, show the cell viability assessment at the maximum flow rate of 0.5 ml/min using the bioink containing different cell concentrations. The maximum flow rate 0.5 ml/min is selected representing the largest shear stress as well as the corresponding maximum cell damage due to the active circulation. It is seen that the cell viability is around 99% at the printing time of 0 minutes. After the printing time of 60 minutes, the cell viability without circulation is around 95.5% and the cell viability with circulation is around 92.6%. The mild cell damage during the active circulation is mainly due to the shear stress within the small silicone tube connecting the top and bottom of the bioink reservoir. This cell viability results indicate that most cells survive during the active circulation and the associated cell damage is almost negligible.

In summary, the disclosed active circulation approach is an effective and efficient approach with superior performance in mitigating cell sedimentation and aggregation in 3D bioprinting.

The bioink used for 3D bioprinting is composed of biological materials and cells. During the printing process, the cells are suspended in the bioink sediment due to the dominant gravitational force. Once the distance between adjacent cells becomes small enough, the cells adhere with each other to form the cell aggregates through cell-cell interaction. The formation of cell aggregates induced by the cell sedimentation plays a critical role in the printing reliability and performance, which have been widely recognized as a significant challenge in 3D bioprinting. The disclosed embodiments are directed to active circulation into the bioink reservoir to mitigate the cell sedimentation and aggregation. The cell sedimentation has been modeled based on iteration with the time step for each divided region of the bioink reservoir. Moreover, the effects of circulation flow rate on the cell sedimentation and aggregation have been investigated and the effectiveness of the disclosed embodiments for bioink with both low and high cell concentrations have been demonstrated.

In accordance with the disclosed embodiments, for the low cell concentration of 1×10⁶ cells/ml, with active circulation the cell concentrations at the top and bottom are 0.96×10⁶ and 1.06×10⁶ cells/ml with the active circulation of 0.5 ml/min, demonstrating the high effectiveness of the active bioink circulation to mitigate the cell sedimentation as disclosed herein. The percentages of the cell aggregates are 67.17% without the active circulation and 13.21% with the active circulation, demonstrating the high effectiveness of the active bioink circulation to mitigate the cell aggregation.

As the flow rate increases from 0 to 0.5 ml/min, the cell concentration at the top increases significantly from 0.07 to 0.96×10⁶ cells/ml, while that at the bottom decreases significantly from 3.68 to 1.06×10⁶ cells/mi. As the flow rate increases from 0 to 0.5 ml/min, the percentage of the individual cells without aggregation increases significantly from 32.83% to 86.79%, while the percentage of cells forming the aggregates decreases significantly from 67.17% to 13.21%. As the flow rate increases from 0.01 to 0.5 ml/min, the mitigation effectiveness on cell sedimentation at the top increases significantly from 33.38% to 96.26%, and that at the bottom also increases significantly from 77.71% to 98.09%. Large flow rate results in slow increments in effectiveness.

For the high cell concentration of 5×10⁶ cells/ml, with the active circulation, the cell concentrations at the top and bottom of the bioink reservoir are 4.13×10⁶ and 6.66×10⁶ cells/ml with the active circulation of 0.5 ml/min. The percentages of the cell aggregates are 51.49% with the active circulation. This demonstrates the high effectiveness of the active bioink circulation to mitigate the cell sedimentation and cell aggregation with high cell concentration.

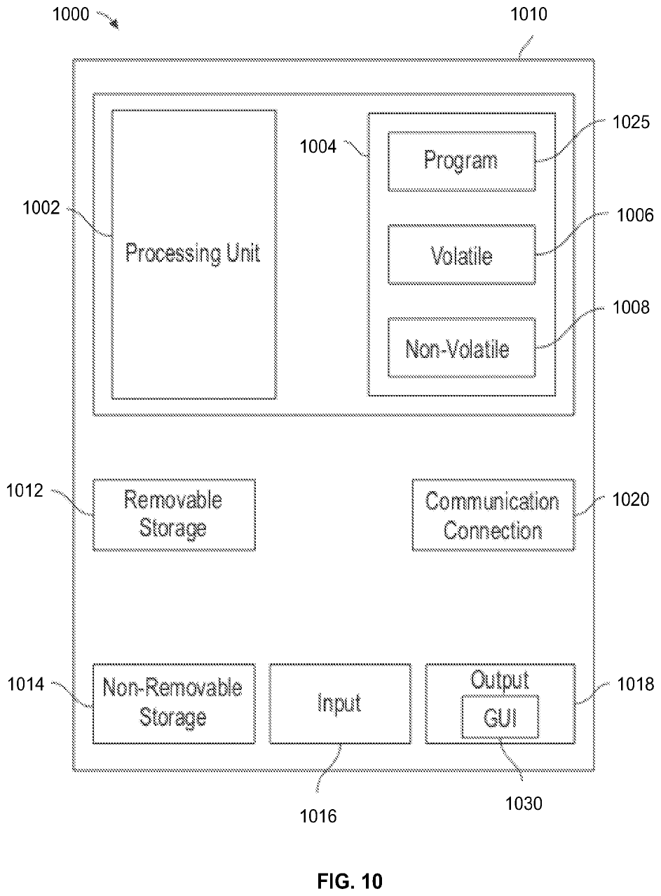

Control of the disclosed systems and associated methods can be realized using computer systems and associated software controls according to the illustrations of FIGS. 10-12.

FIGS. 10-12 are provided as exemplary diagrams of data-processing environments in which embodiments of the present invention may be implemented. It should be appreciated that FIGS. 10-12 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 1000 that executes programming for implementing parts of the methods and systems disclosed herein is shown in FIG. 10. A computing device in the form of a computer 1010 configured to interface with sensors, peripheral devices, and other elements disclosed herein may include one or more processing units 1002, memory 1004, removable storage 1012, and non-removable storage 1014. Memory 1004 may include volatile memory 1006 and non-volatile memory 1008. Computer 1010 may include or have access to a computing environment that includes a variety of transitory and non-transitory computer-readable media such as volatile memory 1006 and non-volatile memory 1008, removable storage 1012 and non-removable storage 1014. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

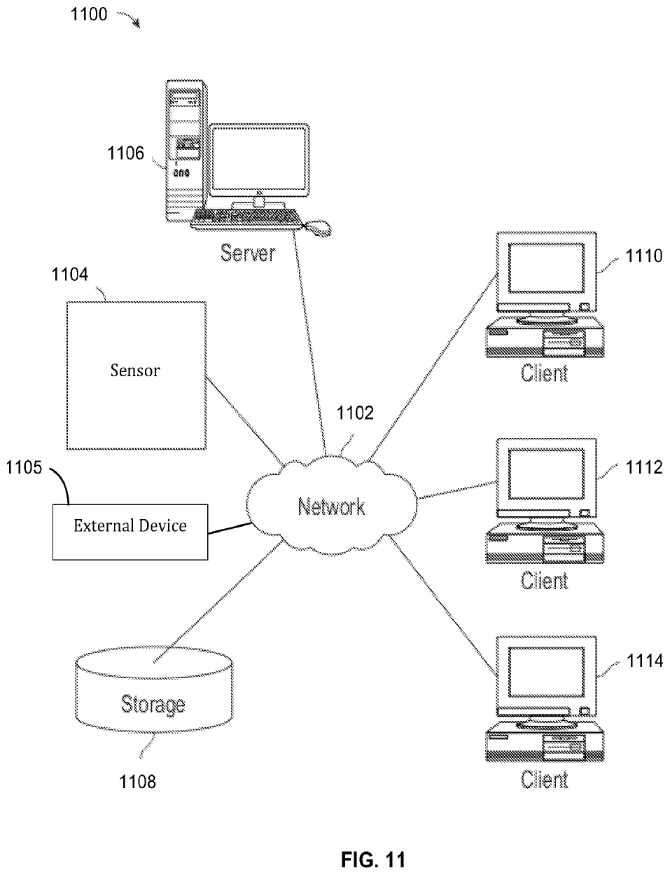

Computer 1010 may include or have access to a computing environment that includes input 1016, output 1018, and a communication connection 1020. The computer may operate in a networked environment using a communication connection 1020 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 11 below.

Output 1018 is most commonly provided as a computer monitor, but may include any output device. Output 1018 and/or input 1016 may include a data collection apparatus associated with computer system 1000. In addition, input 1016, which commonly includes a computer keyboard and/or pointing device such as a computer mouse, computer track pad, or the like, allows a user to select and instruct computer system 1000. A user interface can be provided using output 1018 and input 1016. Output 1018 may function as a display for displaying data and information for a user, and for interactively displaying a graphical user interface (GUI) 1030.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 1016 such as, for example, a pointing device such as a mouse and/or with a keyboard. A particular item can function in the same manner to the user in all applications because the GUI provides standard software routines (e.g., module 1025) to handle these elements and report the user's actions. The GUI can further be used to display the electronic service image frames as discussed below.

Computer-readable instructions, for example, program module or node 1025, which can be representative of other modules or nodes described herein, are stored on a computer-readable medium and are executable by the processing unit 1002 of computer 1010. Program module or node 1025 may include a computer application. A hard drive, CD-ROM, RAM, Flash Memory, and a USB drive are just some examples of articles including a computer-readable medium.

FIG. 11 depicts a graphical representation of a network of data-processing systems 1100 in which aspects of the present invention may be implemented. Network data-processing system 1100 is a network of computers or other such devices such as mobile phones, smartphones, sensors, detection devices, and the like in which embodiments of the present invention may be implemented. Note that the system 1100 can be implemented in the context of a software module such as program module 1025. The system 1100 includes a network 1102 in communication with one or more clients 1110, 1112, and 1114, and external device 1105. Network 1102 may also be in communication with one or more RFID devices, controllers, or sensors 1104, servers 1106, and storage 1108. Network 1102 is a medium that can be used to provide communications links between various devices and computers connected together within a networked data processing system such as computer system 1000. Network 1102 may include connections such as wired communication links, wireless communication links of various types, fiber optic cables, quantum, or quantum encryption, or quantum teleportation networks, etc. Network 1102 can communicate with one or more servers 1106, one or more external devices such as a controller or sensor 1104, and a memory storage unit such as, for example, memory or database 1108. It should be understood device 1104 may be embodied as a mobile device, cell phone, tablet device, waveform generator, pneumatic controller, flowrate controller, imaging system, monitoring device, detector device, sensor microcontroller, controller, receiver, transceiver, or other such device.

In the depicted example, RFID and/or GPS enabled device 1104, server 1106, and clients 1110, 1112, and 1114 connect to network 1102 along with storage unit 1108. Clients 1110, 1112, and 1114 may be, for example, personal computers or network computers, handheld devices, mobile devices, tablet devices, smartphones, personal digital assistants, microcontrollers, recording devices, MFDs, etc. Computer system 1000 depicted in FIG. 10 can be, for example, a client such as client 1110 and/or 1112.

Computer system 1000 can also be implemented as a server such as server 1106, depending upon design considerations. In the depicted example, server 1106 provides data such as boot files, operating system images, applications, and application updates to clients 1110, 1112, and/or 1114. Clients 1110, 1112, and 1114 and RFID and/or GPS enabled device 1104 are clients to server 1106 in this example. Network data-processing system 1100 may include additional servers, clients, and other devices not shown. Specifically, clients may connect to any member of a network of servers, which provide equivalent content.

In the depicted example, network data-processing system 1100 is the Internet with network 1102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1100 may also be implemented as a number of different types of networks such as, for example, an intranet, a local area network (LAN), or a wide area network (WAN). FIGS. 10 and 11 are intended as examples and not as architectural limitations for different embodiments of the present invention.

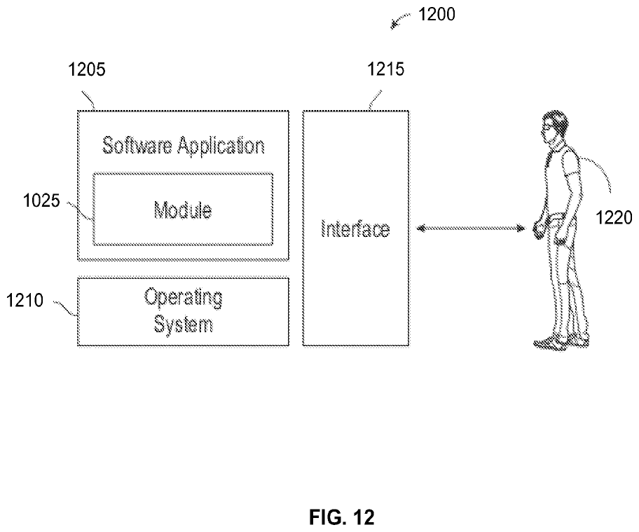

FIG. 12 illustrates a software system 1200, which may be employed for directing the operation of the data-processing systems such as computer system 1000 depicted in FIG. 10. Software application 1205, may be stored in memory 1004, on removable storage 1012, or on non-removable storage 1014 shown in FIG. 10, and generally includes and/or is associated with a kernel or operating system 1210 and a shell or interface 1215. One or more application programs, such as module(s) or node(s) 1025, may be “loaded” (i.e., transferred from removable storage 1012 into the memory 1004) for execution by the data-processing system 1000. The data-processing system 1000 can receive user commands and data through user interface 1215, which can include input 1016 and output 1018, accessible by a user 1220. These inputs may then be acted upon by the computer system 1000 in accordance with instructions from operating system 1210 and/or software application 1205 and any software module(s) 1025 thereof.

Generally, program modules (e.g., module 1025) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1215 (e.g., a graphical user interface 1030) can serve to display results, whereupon a user 1220 may supply additional inputs or terminate a particular session. In some embodiments, operating system 1210 and GUI 1030 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 1210 and interface 1215. The software application 1205 can include, for example, module(s) 1025, which can include instructions for carrying out steps or logical operations such as those shown and described herein.

The following description is presented with respect to embodiments of the present invention, which can be embodied in the context of, or require the use of a data-processing system such as computer system 1000, in conjunction with program module 1025, and data-processing system 1100 and network 1102 depicted in FIGS. 10-12. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

Based on the foregoing, it can be appreciated that a number of embodiments are disclosed herein.

In an embodiment, a system for inkjet bioprinting, comprises a bioink reservoir, an inlet connected to a pump, an outlet from the pump to the bioink reservoir, wherein the pump circulates bioink from the inlet to the outlet. In an embodiment, the outlet is connected to the bioink reservoir above a bioink level in the bioink reservoir. In an embodiment, the inlet is connected to the bioink reservoir below a bioink level in the bioink reservoir. In an embodiment, the system for inkjet bioprinting further comprises a flowrate controller configured to control the flowrate of the pump. In an embodiment, the pump comprises a peristaltic pump. In an embodiment, the system for inkjet bioprinting further comprises a pneumatic controller configured to control back pressure in the bioink reservoir. In an embodiment, the system for inkjet bioprinting further comprises an inkjet dispenser operably connected to the bioink reservoir. In an embodiment, the system for inkjet bioprinting further comprises a waveform generator configured to provide an excitation voltage to the inkjet dispenser. In an embodiment, the system for inkjet bioprinting further comprises bioink comprising ECM and living cells.

In another embodiment, a system comprises an inkjet dispenser, a bioink reservoir configured to deliver bioink to the inject dispenser, an inlet connected to a pump, an outlet from the pump to the bioink reservoir, wherein the pump circulates bioink from the inlet to the outlet. In an embodiment, the outlet is connected to the bioink reservoir above a bioink level in the bioink reservoir, and wherein the inlet is connected to the bioink reservoir below a bioink level in the bioink reservoir. In an embodiment, the system further comprises a flowrate controller configured to control the flowrate of the pump. In an embodiment, the pump comprises a peristaltic pump. In an embodiment, the system further comprises a pneumatic controller configured to control back pressure. In an embodiment, the bioink comprises ECM and living cells.

In an embodiment, a bioink circulation system, comprises a bioink reservoir, an inlet connected to a peristaltic pump, a flowrate controller configured to control the flowrate of the peristaltic pump, and an outlet from the peristaltic pump to the bioink reservoir. In an embodiment the outlet is connected to the bioink reservoir above a bioink level in the bioink reservoir. In an embodiment, the inlet is connected to the bioink reservoir below a bioink level in the bioink reservoir. In an embodiment, the bioink circulation system further comprises a pneumatic controller configured to control back pressure in the bioink reservoir. In an embodiment, the system is configured for circulate bioink comprising ECM and living cells.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system for inkjet bioprinting, comprising:
a bioink reservoir;
an inlet connected to a pump;
an outlet from the pump to the bioink reservoir, wherein the pump circulates bioink from the inlet to the outlet.

2. The system for inkjet bioprinting of claim 1 wherein the outlet is connected to the bioink reservoir above a bioink level in the bioink reservoir.

3. The system for inkjet bioprinting of claim 1 wherein the inlet is connected to the bioink reservoir below a bioink level in the bioink reservoir.

4. The system for inkjet bioprinting of claim 1 further comprising:
a flowrate controller configured to control flowrate of the pump.

5. The system for inkjet bioprinting of claim 1 wherein the pump comprises:
a peristaltic pump.

6. The system for inkjet bioprinting of claim 1 further comprising:
a pneumatic controller configured to control back pressure in the bioink reservoir.

7. The system for inkjet bioprinting of claim 1 further comprising:
an inkjet dispenser operably connected to the bioink reservoir.

8. The system for inkjet bioprinting of claim 7 further comprising:
a waveform generator configured to provide an excitation voltage to the inkjet dispenser.

9. The system for inkjet bioprinting of claim 1 wherein the bioink comprises:
ECM; and
living cells.

10. A system comprising:
an inkjet dispenser;
a bioink reservoir configured to deliver bioink to the inkjet dispenser;
an inlet connected to a pump;
an outlet from the pump to the bioink reservoir, wherein the pump circulates bioink from the inlet to the outlet.

11. The system of claim 10 wherein the outlet is connected to the bioink reservoir above a bioink level in the bioink reservoir, and wherein the inlet is connected to the bioink reservoir below a bioink level in the bioink reservoir.

12. The system of claim 10 further comprising:
a flowrate controller configured to control flowrate of the pump.

13. The system of claim 10 wherein the pump comprises:
a peristaltic pump.

14. The system of claim 10 further comprising:
a pneumatic controller configured to control back pressure.

15. The system of claim 10 wherein the bioink comprises:
ECM; and
living cells.

16. A bioink circulation system, comprising:
a bioink reservoir;
an inlet connected to a peristaltic pump;
a flowrate controller configured to control flowrate of the peristaltic pump;
an outlet from the peristaltic pump to the bioink reservoir.

17. The bioink circulation system of claim 16 wherein the outlet is connected to the bioink reservoir above a bioink level in the bioink reservoir.

18. The bioink circulation system of claim 16 wherein the inlet is connected to the bioink reservoir below a bioink level in the bioink reservoir.

19. The bioink circulation system of claim 16 further comprising:
a pneumatic controller configured to control back pressure in the bioink reservoir.

20. The bioink circulation system of claim 16 wherein the system is configured to circulate bioink comprising:
ECM; and
living cells.
